(19) United States
(12) Patent Application Publication
(10) Pub. No.: US 2018/0158146 A1
(43) Pub. Date: Jun. 7, 2018

(54) Financial Operating Platform For Autonomous And Semi-Autonomous Cash Forecasting And Projecting Financial Results

(71) Applicant: Trovata, Inc., San Diego, CA (US)

(72) Inventors: Brett P. Turner, Solana Beach, CA (US); Edward R. Barrie, Liberty Lake, WA (US); Chris Carter, Wenatchee, WA (US)

(21) Appl. No.: 15/828,254

(22) Filed: Nov. 30, 2017

Related U.S. Application Data
(60) Provisional application No. 62/429,002, filed on Dec. 1, 2016.

(51) Int. Cl. G06Q 40/06; G06Q 40/02

(52) U.S. Cl. CPC G06Q 40/06; G06Q 40/02

(57) ABSTRACT

A platform is disclosed for autonomous or semi-autonomous generation of financial reports. Financial data is received from a plurality of data sources, the data sources each being connected with the computer processor, the data sources comprising one or more of a financial institution, an enterprise resource planning (ERP) system, external market data, user-generated content, and external global market news and events. The financial data is then aggregated in a cloud based server platform, and then processed to automatically generate one or more financial reports, the one or more financial reports including cash positions, a cash flow forecast, a treasury management report, financial performance, and/or operational performance metrics. The one or more financial reports are delivered to a client computing device based on a selection received from a user of the client computing device.

### CROSS REFERENCE TO RELATED APPLICATIONS

This application claims the benefit of U.S. Provisional Application Ser. No. 62/429,002, entitled “Financial Operating Platform For Autonomous And Semi-Autonomous Cash Forecasting And Projecting Financial Results”, filed on Dec. 1, 2016. The disclosure of the above-identified patent application is hereby incorporated by reference in its entirety.

### TECHNICAL FIELD

The subject matter described herein relates to a financial operating platform, and more particularly to a system and method for autonomous and semi-autonomous cash forecasting and projecting financial results.

### BACKGROUND

An enterprise has three primary financial operating functions: Accounting; Financial Planning and Analysis (FP&A); and Treasury. Generally, accounting compiles historical financial performance following standards as provided by generally accepted accounting principles (GAAP). FP&A analyzes and produces forward-looking financial assessments forecasting cash positions, trends, and financial projections. Finally, treasury uses the information provided by accounting and FP&A, along with external market data, to optimize cash liquidity and yield on investments, while managing risk.

While these three functions have many interdependencies, they general operate separately from one another as the skills required to perform the duties of each function are different. As a result, the systems used by each, and the many work flows to produce desired results for each, can be disparate and involve manual processes. Most companies today still rely heavily on spreadsheets for many core or critical tasks, especially for cash forecasting and financial projections.

Conventional platforms or processes for creating a cash forecast, which is what a company estimates as its cash position in the future that is derived from various data sources and compiled by its finance staff, is labor intensive. Traditionally, a financial analyst compiles the data from discussions with employees from others departments (i.e., sales, human resources, engineering, operations, customer service, etc.) within the company, along with data from its internal business and accounting systems. Once all the data is gathered, it is manually inputted or imported into spreadsheets (i.e., Microsoft Excel® or Google Sheets®, or the like), often within a financial model that is manually created, configured and maintained. A considerable amount of effort and analysis is often required and expended in computing the forecast using a spreadsheet, because of its natural reliance on human input and control. Once the cash forecast is determined, it then must be output to certain reports and communicated to managers for review and decision making.

### SUMMARY

This document describes a system and method for autonomous and semi-autonomous cash forecasting and projecting financial results for an enterprise. The system and method can be implemented on a computer-based software and hardware platform that includes one or more computer processors. The software and hardware platform is scalable both to incorporate a large number of enterprises and to varying degrees or amounts of financial complexity. The financial operating platform described herein is designed to automate all or much of the labor-intensive processes of conventional accounting, FP&A, and treasure functions, and results in considerable gains in efficiency for the enterprise.

In one aspect, a computing system, computer-implemented method and computer program product execute a process for autonomous and semi-autonomous cash forecasting and projecting financial results for an enterprise. The process includes the steps of receive financial data from a plurality of data sources, the data sources each being connected with the computer processor, the data sources comprising one or more of a financial institution, an enterprise resource planning (ERP) system, external market data, user-generated content, and external global market news and events.

The process further includes steps to aggregate the financial data in a cloud based server platform, and to process, using filtering, querying, correlating, linking, calculating, and/or analyzing according to one or more algorithms, the financial data in the cloud based server platform to automatically generate one or more financial reports, the one or more financial reports including cash positions, a cash flow forecast, and/or a treasury management report. The process further includes a step to deliver, from the cloud based server platform to a client computing device, the one or more financial reports based on a selection received from a user of the client computing device.

Implementations of the current subject matter can include, but are not limited to, systems and methods, as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a functional block diagram of a system for autonomous cash forecasting and projecting of financial results.

FIG. 2 is a screen shot of a user interface (UI) having user-interactive functional and informative elements therein.

When practical, similar reference numbers denote similar structures, features, or elements.

### DETAILED DESCRIPTION

This document describes a system and method for autonomous and semi-autonomous cash forecasting and projecting financial results. The system and method can be implemented as a computer-based software and hardware platform that includes one or more computer processors.

In one aspect, a computer-based financial operating platform is provided to seamlessly automate many of the operational tasks across all financial functional areas within the enterprise, which include accounting, FP&A, and treasury. The platform functions as a financial data aggregation hub, having a machine-readable medium storing non-transitory instructions that enables one or more computer processors to execute software algorithms to make intelligent associations between data elements to compute, analyze, and predict financial results. The systems and methods described herein generate efficiencies, improve accuracy, add precision, and enable real-time visibility of current and future financial positions and performance.

In one aspect, the financial operating platform (1) acquires and aggregates proprietary and non-proprietary financial data from external and internal sources, including but not limited to financial institutions, business systems or spreadsheets (i.e., Salesforce.com, Workday, Excel, etc.), accounting systems (i.e., Netsuite, SAP, etc.), market data (i.e., foreign exchange rates, interest rates, world news & events, etc.), and user-generated content; (2) securely stores, manages, monitors, the data; (3) compiles, processes, connects, computes, and enriches the data; and (4) autonomously and/or semi-autonomously forecasts and projects cash, financial positions, and financial performance data and metrics. The financial operating platform, through all of these functions, serves companies by streamlining or automating many financial computations that are currently performed manually or with the use of spreadsheets.

In another aspect, by acquiring and aggregating all such data from the various sources as described above, most of which come from disparate or “siloed” systems, the financial operating platform can provide historical cash and financial positions that are significantly more meaningful and that can be significantly enhanced because the data collectively makes for a more complete picture for end users, and as a result, new conclusions can be derived and more in-depth analytics can be executed when the data is brought together.

By connecting to various data sources using application programmable interfaces (APIs), the financial operating platform can retrieve the many required data elements to compute the cash forecast autonomously. For example, by connecting with Salesforce.com®, the financial operating platform can retrieve a company's sales estimates as projected and planned by a company's sales team. That sales data can then be used to determine a company's future revenue based on historical performance and other criteria. Once revenue is determined, this inherently determines what a company's Accounts Receivable (AR) balances will be at certain points in time. Furthermore, once a company's AR balances are determined, and using a company's actual collections history by its customers, cash receipts at certain future dates can then be determined. Therefore, by connecting to the various business and accounting systems of a company, all or much of the data can be retrieved and subsequently used to calculate the cash forecast in an autonomous or semi-autonomous fashion. Similarly, by connecting into an Enterprise Resource Planning (ERP) system such as Netsuite®, the financial operating platform can retrieve the AR and Accounts Payable (AP) balances that will convert to cash based on a customer's payment terms and its actual payment history, as well as the company's own payment policies with vendors, respectively.

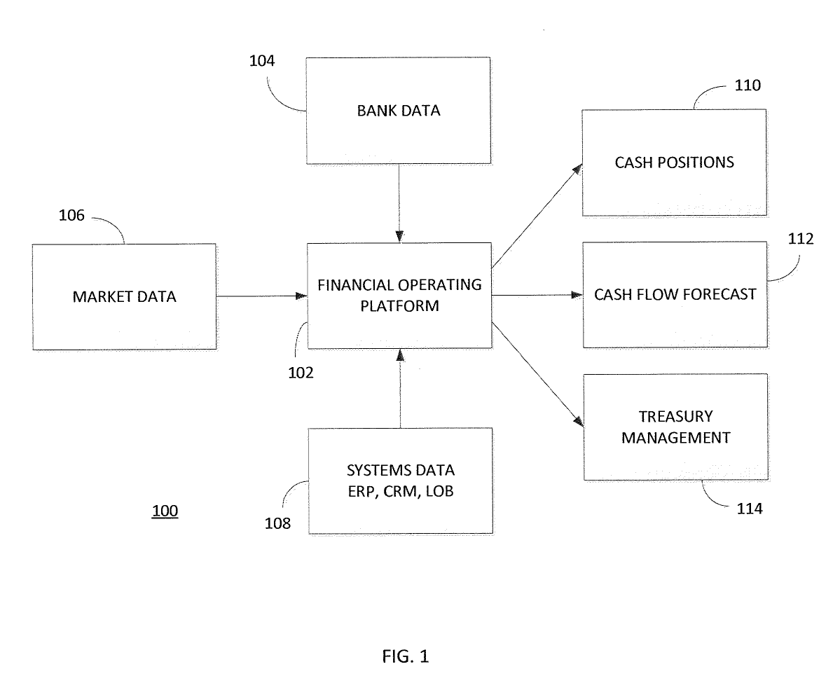

In accordance with exemplary implementations, a computer-based system 100 includes a financial operating platform 102, as generally shown in FIG. 1. The financial operating platform 102 includes inputs for receiving bank data 104, market data 106, and systems data 108, such as ERP, CRM, LOB data, or the like. The system 100 is configured to seamlessly automate many of the operational tasks across all financial functional areas within an enterprise, which include accounting, financial planning and analysis (FP&A), and treasury. The platform provides a hub for financial data aggregation, and includes a machine-readable medium storing non-transitory instructions that enables one or more computer processors to execute software algorithms to make intelligent associations between data elements to compute, analyze, and predict financial results. The outputs of the financial operating platform 102 include cash positions 110, cash flow forecasts 112, and treasury management 114.

In some implementations, the platform includes the following distinct functional modules: (1) data acquisition; (2) data processing; and (3) financial applications.

(1) Data Acquisition and Aggregation:

The platform acquires data from at least the following five primary sources: (a) financial institutions; (b) enterprise Resource Planning (ERP) and other business systems or applications that the enterprise depends on to operate; (c) external market data, such as foreign exchange rates or interest rates that can be acquired from third-party aggregators; (d) user-generated content, such as cash forecasting assumptions determined by a company's finance staff; and (e) external global market news and events that could affect a company's assets or financial performance. The platform is connected with each of these data sources via one or more computer communication networks, and via any number of interfaces such as application programming interfaces (APIs). These connections can be configured to enable the platform to automatically “pull” in the relevant data from each of the data sources, or have the data sources automatically “push” the relevant data to the platform, or both. The relevant data can be determined and set by a user, or the platform can utilize machine learning algorithms to intelligently “learn” which data is relevant for the platform's functionality.

The platform is not tied to the data sources listed above; it takes advantage of a flexibly configured ingestion layer that can pull data from any number or type of yet to be known systems, or receive push communications with standardized data across numerous possible communication channels to create new or enriched data sets within the data lake.

The platform aggregates data from these sources into its cloud-native platform, i.e., one or more server computers that are accessible by one or more client computers via a computer network, and securely stores, monitors, manages, and protects this data in the cloud on behalf of its customers.

The platform architecture consists of a data lake that stores the data, in whichever format the source data provides it, or a sensible amalgamation (for example, raw database data can be stored in CSV or JSON format). The storage format can be structured, unstructured or semi-structured data. The data lake can include a database formed in a computer storage or memory subsystem. The data lake maintains an ever-growing historical view of original financial data for any company. This corpus of data allows the further components of the platform or system to be continuously enhanced without necessarily requiring new data to be input.

(2) Data Processing

The platform enriches the raw data it aggregates through a process of filtering, querying, correlating, linking, calculating, and analyzing, using algorithms it either generates or was generated directly or indirectly through machine learning methods. The platform's enriched data allows it to automate many common work flows that are currently performed either manually or semi-manually via spreadsheets within most business's conventional finance, accounting, and treasury functions. The platform's data processing drives work flow automation in many different areas of finance, accounting, and treasury operations.

Making associations between the many different types of data from the many different sources and processing the raw data to produce enriched data, allows the platform to provide insights to a business's health and financial operating performance. Furthermore, it becomes a powerful tool for the enterprise to report on, manage and forecast cash, along with managing treasury functions like minimizing foreign currency exposure, optimizing yield on investments, and other risk management activities.

The platform architecture includes one or more databases that are derived from ingested data in the data lake using query methods and analytical tools such as full-text search engines and distributed in-memory frameworks, in conjunction with the various algorithms and methods to determine certain outputs that become the content used by its many applications for the platform's end user customers. These applications are designed to compute or solve business and financial problems, create or improve work flows and efficiencies, replace, improve, or augment spreadsheet work or processes, and report data in meaningful ways that provide significant leverage or automation across the finance, accounting, and treasury departments.

The prescriptive application of advanced statistical modeling tools is also computed over the entire corpus of the financial data set for a customer or many customers, both on-demand and in real-time. This allows, for instance, machine learning to be active as data flows through the system and can provide scoring, classification, prediction and other derived metrics to other processing components as they work, rather than using an after the fact method as many competitive systems will eventually have to.

(3) Financial Applications:

The platform uses enriched data it has collected to deliver efficiencies to businesses through a variety of applications including, but not limited to the following: connectivity to financial institutions, connectivity to SWIFT, financial connectivity performance monitoring, data access for Business Intelligence (BI) software, financial reporting, data conversion, data translation, cash positions, general ledger transactions, transaction matching, cash reconciliation, cash forecasting, cybersecurity, specialized reporting, systems integration, data analytics, bi-directional Excel interface, payments, merchant settlement, Foreign Exchange (FX) exposure capture and trading, compliance, intercompany netting, in-house bank, bank fee analysis, entity management, debt management, interest rate exposure and trading, investment management, trade services, derivatives processing, hedge accounting, commodities exposure capture and trading, and risk management.

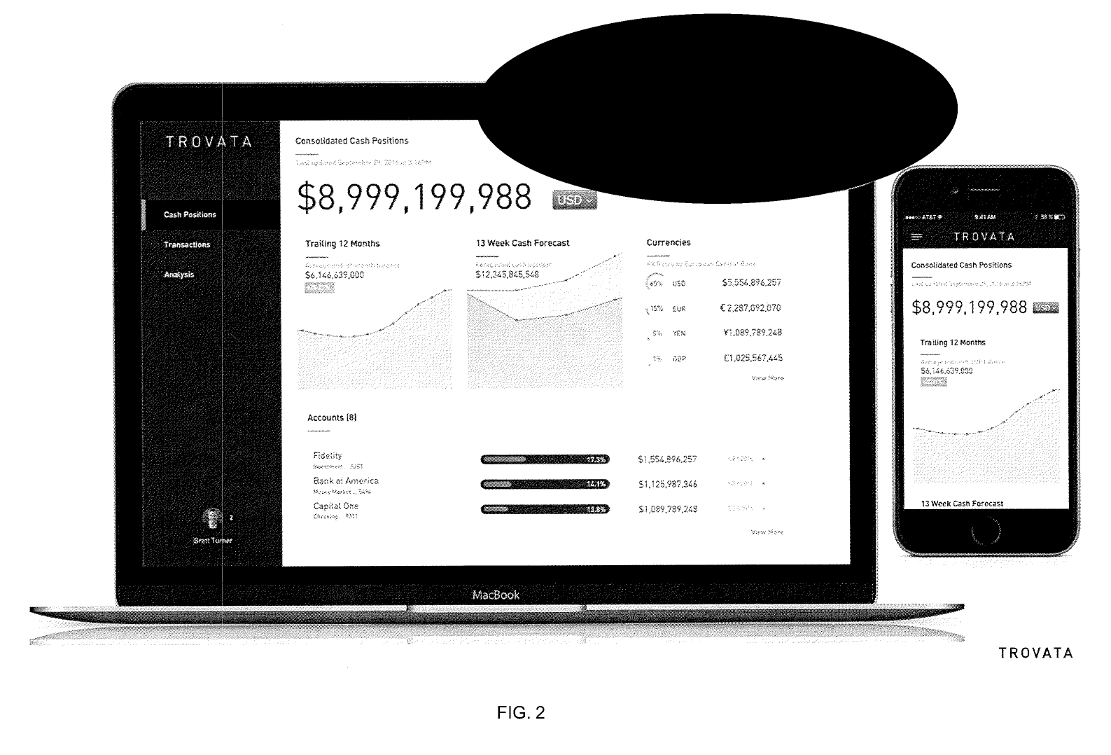

As part of its functionality, the platform delivers data and enriched data, as depicted in FIG. 2, through many channels of distribution, including, but not limited to:

1) Web application

2) Mobile application

3) External managed BI tool

4) Internally hosted (built-in) BI tool

5) Externally managed spreadsheet

6) Internally hosted (built-in) spreadsheet

7) REST API access

The platform gathers data from multiple sources, enriches that data by making associations amongst the data when aggregated or by its own computations from what it recognizes or processes, and then distributes results through a variety of applications. The system distributes results through a variety of applications that become the basis for reporting financial items, results, or performance in a more efficient manner, and becomes an intelligent hub of information for platform-proprietary applications, third-party applications or third-party developers, and for making more informed business decisions.

In some implementations, the system uses the enriched data to predict or forecast (i) future cash flows; (ii) future cash positions; (iii) financial performance; (iv) financial or business metrics; (v) financial or business results; and (vi) events. The system uses the enriched data to distribute or report real-time financial results, performance, metrics, KPIs, and other data. The system uses the enriched data to provide treasury management system features and functionality like cash positions, account reconciliations, general ledger transactions, transaction matching, cash reconciliations, cash forecasting, cybersecurity, specialized reporting, payments, merchant settlement, Foreign Exchange (FX) exposure capture and trading, compliance, intercompany netting, in-house bank, bank fee analysis, entity management, bank account management, debt management, interest rate exposure and trading, investment management, trade services, derivatives processing, hedge accounting, commodities exposure capture and trading, and risk management.

The platform's methods of distributions include web applications, mobile applications, through business intelligence applications, to business intelligent applications, through spreadsheets, to spreadsheets, to other media and other third-party systems using APIs or other methods.

The platform seeks to change, augment, or improve, the current global cycles for financial reporting and analysis, which is generally performed monthly, quarterly, and annually, by automating the methods of compiling and predicting the financial results of a company's performance through data aggregation using machine learning, quantitative analysis, and other machine-based statistical and derived methods.

The platform combines data from financial institutions, business and accounting (ERP or other) systems, and external market data to derive a company's future outcome of financial performance, and further combines internally derived assumptions to derive a company's future outcome of financial performance.

The platform provides for enhanced cybersecurity. Using modern mobile platforms and the enriched data sets available in its data lake, the platform can drive a greatly enhanced standard for security between financial systems and within the financial sector in general: Mobile devices can be used to drive new methods of authenticating financial actions such as payments and transfers as well as drive verification of other actions toward a more-real time level of auditing and awareness. The vast trove of data available to the platform can be actively mined and profiled to produce a more integrated approach to fraud detection and security analysis that other siloed systems do not have available. In addition, the platform's data acquisition process captures not only data at rest, but can also integrate into the data lake behavioral data of information flowing through it which provides a much more latent capacity for security analysis.

Automated cash forecast—the platform can execute a traditional cash forecast to understand a company's financial health, performance, and for management to make informed decisions to meet strategic or operating objectives. The platform displaces the enterprise's current process, which is typically done manually using spreadsheets to calculate such results. The platform automates the cash forecast by leveraging its data aggregation and data processing methods to calculate and derive current and future cash flows. Such methods use historical financial data and derived data using algorithms that predict future cash flows and cash positions analyzing trends from, but not limited to, sales, expenses, receivables, payables, proceeds, payments, inventory, and depreciation and other non-cash items. This generates considerable time savings while producing more accurate results in a timelier manner.

Predictive analytics—the platform can leverage its ‘big data’ platform to calculate and derive Key Performance Indicators (KPIs) and other statistics to report and score a company's operating performance. For instance, using accounts receivable and accounts payable data from a company's accounting or ERP system coupled with historical cash transactions, the platform can derive a company's working capital ratios, such as Days Receivable Outstanding (DRO) and Days Payable Outstanding (DPO).

Predictive financials—The platform can leverage its “big data” configuration to calculate and derive financial operating performance from data processing methods using data from multiple sources and various types of data, such as a company's historical bank balances and transactions, cash flow types, accounting system data, and world events, and data from key customers.

Predictive financial metrics using platform insights—Using data from all its customers across its entire platform at scale and anonymously, the platform can generate more accurate financial performance metrics and improve the accuracy of its forecasting capabilities at a detailed level for the benefit of individual companies.

Quote-to-Cash Metrics—the platform can autonomously or semi-autonomously compute the number of days it takes for a sale to be quoted to a customer and then later be fully collected after it converts to an accounts receivable. With the platform integrated with the various data sources from its business systems, ERP system, and bank, a digital time line can be recorded, analyzed, computed, and reported in real time or near real time. The measurement can be used as a highly effective metric for measuring a company's operational performance.

Automated reporting—the platform brings a company's data together from many sources and significantly improves the efficiency of financial reporting, planning, and analysis using multiple reporting mediums.

Financial data tagging—the platform tags data as part of its data enrichment process. These tags enhance the meaning of transactions with description identifiers using words, phrases or iconography. The platform allows users to add tags via its interface, which is captured as part of user-generated content.

User Tagging with Comments—Users, via the platform's user interface (UI) can input comments as tags that temporarily or permanently stay connected to data within the platform's integrated systems, such as comments for variances analysis. For example, if a change in cash position goes up by 30% month over month, the user can add a comment that explains such variance. Such comment(s) can be stored and connected to the financial data to which it applies, and can be accessible for future use and analysis, such as with historical analysis of similar data.

User Tagging “N words or less”—In providing users with the ability to add tags or comments to variances or other financial data that adds descriptive information helpful to other users, the platform may capture a specific limited number of words tag that becomes the standard descriptive tagging element for user engagement. In some implementations, the number of words is five, but more or fewer words can also be used.

Financial Operating Platform—The platform creates efficiencies across Accounting, Finance, and Treasury departments by aggregating information from banks, internal systems, and external market data and then uses that information to perform and complete many jobs, duties, and tasks that are currently performed manually by people or in connection with spreadsheets. The platform displaces manual and spreadsheet work to save time and money, and also enables insight and visibility to future financial positions and performance in real- or near real-time giving executive management, such as the CFO, access to information much more quickly than can be currently generated.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method of autonomous and semi-autonomous cash forecasting and projecting financial results, the method comprising:
receiving, by a computer processor, financial data from a plurality of electronic data sources, the electronic data sources each being connected with the computer processor via a communications network, the electronic data sources comprising one or more of a financial institution, an enterprise resource planning (ERP) system, external market data, user-generated content, and external global market news and events;
aggregating, by the computer processor, the financial data in a cloud-based server platform;
processing, by the computer processor using filtering, querying, correlating, linking, calculating, and/or analyzing according to one or more algorithms, the financial data in the cloud based server platform to automatically generate one or more financial reports, the one or more financial reports including cash positions, a cash flow forecast, and/or a treasury management report; and
delivering, by the computer processor from the cloud based server platform to a client computing device, the one or more financial reports based on a selection received from a user of the client computing device.

2. The method in accordance with claim 1, wherein the delivering is performed via a web application.

3. The method in accordance with claim 2, wherein the client computing device is one of a desktop computer and a mobile computing device.

4. The method in accordance with claim 1, wherein the processing further includes formatting the one or more financial reports in a format that is deliverable via an application programming interface (API).

5. A non-transitory computer program product storing instructions that, when executed by at least one programmable processor, cause the at least one programmable processor to perform operations comprising:
receive financial data from a plurality of data sources, the data sources each being connected with the computer processor, the data sources comprising one or more of a financial institution, an enterprise resource planning (ERP) system, external market data, user-generated content, and external global market news and events;
aggregate the financial data in a cloud based server platform;
process, using filtering, querying, correlating, linking, calculating, and/or analyzing according to one or more algorithms, the financial data in the cloud based server platform to automatically generate one or more financial reports, the one or more financial reports including cash positions, a cash flow forecast, and/or a treasury management report; and
deliver, from the cloud based server platform to a client computing device, the one or more financial reports based on a selection received from a user of the client computing device.

6. The computer program product in accordance with claim 5, wherein the delivering is performed via a web application.

7. The computer program product in accordance with claim 6, wherein the client computing device is one of a desktop computer and a mobile computing device.

8. The computer program product in accordance with claim 5, wherein the processing further includes formatting the one or more financial reports in a format that is deliverable via an application programming interface (API).

9. A system comprising:
at least one programmable processor; and
a machine-readable medium storing instructions that, when executed by the at least one processor, cause the at least one programmable processor to perform operations comprising:
receive financial data from a plurality of data sources, the data sources each being connected with the computer processor, the data sources comprising one or more of a financial institution, an enterprise resource planning (ERP) system, external market data, user-generated content, and external global market news and events;
aggregate the financial data in a cloud based server platform;
process, using filtering, querying, correlating, linking, calculating, and/or analyzing according to one or more algorithms, the financial data in the cloud based server platform to automatically generate one or more financial reports, the one or more financial reports including cash positions, a cash flow forecast, and/or a treasury management report; and
deliver, from the cloud based server platform to a client computing device, the one or more financial reports based on a selection received from a user of the client computing device.

10. The system in accordance with claim 9, wherein the delivering is performed via a web application.

11. The system in accordance with claim 10, wherein the client computing device is one of a desktop computer and a mobile computing device.

12. The system in accordance with claim 9, wherein the processing further includes formatting the one or more financial reports in a format that is deliverable via an application programming interface (API).
